(19) United States
(12) Patent Application Publication
(10) Pub. No.: US 2012/0251656 A1
(43) Pub. Date: Oct. 4, 2012

(54) INJECTION MOLD

(75) Inventors: XIAN-YUN WANG, Dong-Guan (CN); XIAO-PING WU, Dong-Guan (CN); KUN-HSUEH CHIANG, New Taipei City (TW)

(73) Assignee: Cheng Uei Precision Industry Co., LTD., New Taipei City (TW)

(21) Appl. No.: 13/077,966

(22) Filed: Mar. 31, 2011

(51) Int. Cl. B29C 45/44; B29C 45/40; B29C 45/26

(52) U.S. Cl. 425/556

(57) ABSTRACT

An injection mold for molding a product having a barb at a bottom thereof includes a stationary mold, a movable mold, an ejector pin and a sliding mechanism. The sliding mechanism includes a sliding block mounted on the movable mold, a spring contracted between the sliding block and the movable mold, and a locating element vertically inserted in the spring. A top end of the locating element stretches in the receiving cavity. A corner of the sliding block defines a nick connected for molding the barb. When the injection mold is opened, the sliding block moves upward under the bounce thrust of the spring to make the product parted from the top of the movable mold. An elastic retraction area is accordingly formed between the product and the movable mold for assisting the ejector pins to eject the barb out of the sliding block.

### BACKGROUND OF THE INVENTION

1. Field of the Invention

The present invention generally relates to an injection mold, and more particularly to an injection mold capable of ejecting a product out effectively.

2. The Related Art

Generally, a conventional injection mold for molding a product which has a barb at a bottom of the product includes a stationary mold and a movable mold. The movable mold includes a movable plate, a movable core mounted in a middle of a top of the movable plate, a sliding block mounted on one side of the movable plate, and a plurality of ejector pins inserted in the movable mold and penetrating through the movable core. When the injection mold is closed, a shaping cavity for molding the product is formed among the stationary mold, the movable core and the sliding block. When the injection mold is opened, the ejector pins move upward to eject the product out of the injection mold. Then the barb of the product is further parted from the sliding block by means of moving the sliding block upward and sideward by other complex auxiliary jigs. However, there is no refraction area between the barb of the product and the movable core, so the product is apt to cause a deformation under a strong traction of the auxiliary jigs. Furthermore, the sliding block occupies a larger area in the injection mold along a vertical direction and a horizontal direction, so a large space is occupied by the injection mold to increase manufacturing cost of the injection mold. The complex auxiliary jigs are needed to part the product from the sliding block that increases the cost of manufacturing the product. As a result, production efficiency of the injection mold is lowered.

### SUMMARY OF THE INVENTION

An object of the present invention is to provide an injection mold for molding a product having a barb at a bottom thereof. The injection mold includes a stationary mold, a movable mold, an ejector pin and a sliding mechanism. The stationary mold defines a sprue channel. A bottom of the stationary mold is concaved upward to form a groove. The movable mold is positioned under the stationary mold when the injection mold is closed. The movable mold includes a movable core which has a top thereof received in the groove of the stationary mold and spaced from an inner periphery of the groove to define a base groove therebetween. The ejector pin is movably inserted in the movable mold for ejecting the product out of the injection mold. The sliding mechanism includes a sliding block movably mounted on a top of the movable mold and adjacent to one side of the movable core, a spring contracted between the sliding block and the movable mold, and a locating element vertically inserted in the spring through the sliding block. A top of the sliding block abuts against the bottom of the stationary mold to together define a receiving cavity therebetween. A bottom end of the locating element is fastened to the movable mold and a top end thereof stretches in the receiving cavity. A corner of the sliding block adjacent to the movable core defines a nick connected with the base groove for molding the barb of the product. The nick cooperates with the base groove to together define a shaping cavity for molding the product. When the injection mold is opened, the sliding block moves upward under the bounce thrust of the spring and the guide of the locating element along the one side of the movable core to make the product parted from the top of the movable core. The top end of the locating element can resist against a bottom side of the receiving cavity to block the sliding block overly moving upward. An elastic refraction area is accordingly formed between the product and the movable core for assisting the ejector pins to eject the barb out of the sliding block.

As described above, when the injection mold is opened, the ejector pin moves upward to push a bottom of the product upward to make the barb of the product parted from the sliding block. The barb can be retracted towards the movable core through the elastic retraction area, so the barb is able to be parted from the sliding block directly without any deformation. Therefore, the product can be ejected out of the movable mold effectively to ensure a production of the product. Furthermore, the sliding block is driven to vertically move upward and downward along the side surface of the movable core under the cooperation of the locating element and the spring, so the sliding block occupies a smaller area in the injection mold to make the injection mold occupy a smaller area. So cost of manufacturing the injection mold is decreased, and production efficiency of the injection mold is improved.

### BRIEF DESCRIPTION OF THE DRAWINGS

The present invention will be apparent to those skilled in the art by reading the following description, with reference to the attached drawings, in which:

FIG. 1 is a sectional view of an injection mold according to the present invention, wherein the injection mold is closed with a product being molded therein;

FIG. 2 is a sectional view of the injection mold of FIG. 1, wherein the injection mold is opened with a barb of the product being remained therein; and

FIG. 3 is a sectional view of the injection mold of FIG. 1, wherein the injection mold is opened with the product being ejected out therefrom.

### DETAILED DESCRIPTION OF THE EMBODIMENT

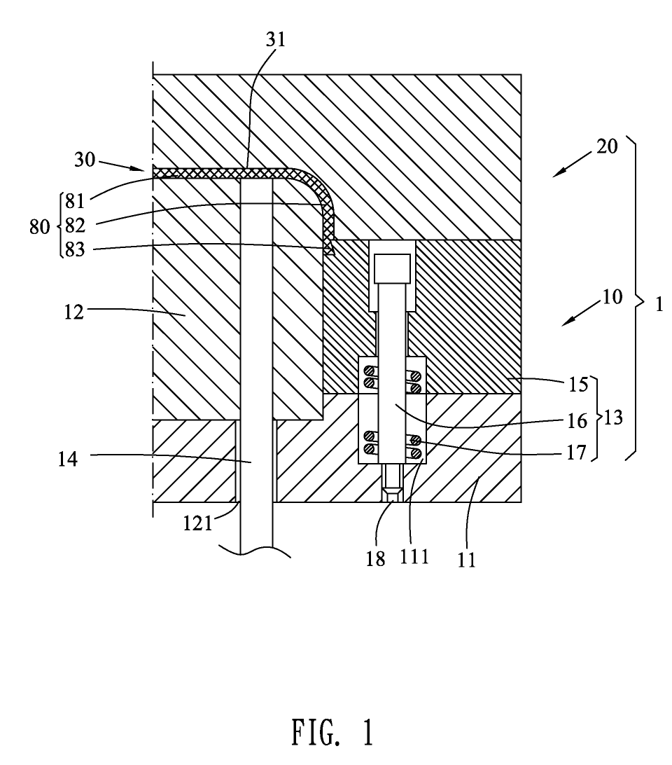

Referring to FIG. 1, an embodiment of an injection mold 1 according to the present invention is shown. The injection mold 1 adapted for molding a product 80 includes a movable mold 10, a stationary mold 20 positioned over the movable mold 10 and a sliding mechanism 13 movably mounted on the movable mold 10.

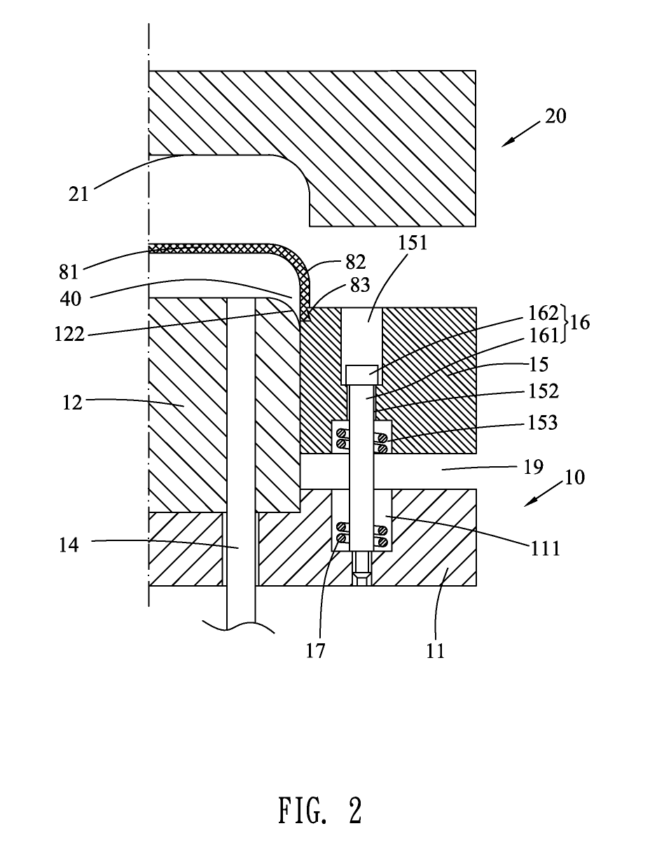

Referring to FIGS. 1-2, the movable mold 10 includes a movable plate 11, a movable core 12 mounted in a substantial middle of a top of the movable plate 11 and an ejector pin 14. Each side of a top surface of the movable core 12 defines an arc-shaped interface 122 smoothly connecting with the top surface and a corresponding side surface of the movable core 12. The sliding mechanism 13 includes a sliding block 15, a substantial T-shaped locating element 16 from a front view and a spring 17. The sliding block 15 is movably mounted on one side of a top of the movable plate 11 and adjacent to the corresponding side surface of the movable core 12. A corner of one side of the sliding block 15 adjacent to the movable core 12 defines a nick 154. A top of the sliding block 15 defines a rectangular receiving cavity 151. A bottom of sliding block 15 defines a first receiving groove 153 passing therethrough. A connecting groove 152 is connected between a middle of a bottom of the receiving cavity 151 and a middle of a top of the first receiving groove 153. The top of the movable plate 11 defines a second receiving groove 111 matching with the first receiving groove 153. The locating element 16 has an inserting portion 161 disposed vertically, and a blocking portion 162 perpendicularly connected with a top end of the inserting portion 161. The spring 17 is positioned in the second receiving groove 111 and the first receiving groove 153. The inserting portion 161 of the locating element 16 is inserted in the spring 17 through the receiving cavity 151 and the connecting groove 152 for locating the sliding block 15 on the top of the movable plate 11. Bottoms of the spring 17 and the inserting portion 161 of the locating element 16 abut against an inner sidewall of the second receiving groove 111, and the bottom of the inserting portion 161 of the locating element 16 is fastened to the movable plate 11 by a screw 18. Contraction and extension of the spring 17 can control the sliding block 15 to move upward and downward. The movable mold 10 defines an ejector pin hole 121 penetrating through the movable plate 11 and the movable core 12. A bottom end of the ejector pin 14 is mounted on top of a fixing plate (not shown). The fixing plate can be movably assembled to a bottom of the movable mold 20 to drive the ejector pin 14 to move up and down along the ejector pin hole 121.

Referring to FIGS. 1-2 again, a substantial middle of a bottom of the stationary mold 20 is concaved upward to form a groove 21 facing to a top of the movable core 12. The stationary mold 20 defines a sprue channel (not shown).

Referring to FIGS. 1-2, when the injection mold 1 is closed, the fixing plate drives the ejector pin 14 to move upward to make a top of the ejector pin 14 be in alignment with the top surface of the movable core 12. The sliding block 15 is pressed on the top of the movable plate 11, and located lower than the top of the movable core 12. The spring 17 shows a contracting status in the first receiving groove 153 and the second receiving groove 111. The blocking portion 162 of the locating element 16 stretches in the receiving cavity 151 and is spaced from an inner bottom sidewall of the receiving cavity 151. The top of the movable core 12 is received in the groove 21 of the stationary mold 20 and spaced from an inner periphery of the groove 21 to define a base groove 31 therebetween. The base groove 31 is connected with and cooperates with the nick 154 to together define a shaping cavity 30 communicating with the sprue channel. Then thermoplastic resins are injected into the shaping cavity 30 of the injection mold 1 through the sprue channel. The thermoplastic resins are solidified for a predetermined time to form the product 80 in the shaping cavity 30. The product 80 includes a base portion 81 and a bending portion 82 bended downward from an end of the base portion 81. An outer side of a bottom of the base portion 81 has a barb 83. The base portion 81 and the bending portion 82 are molded in the base groove 31 and the barb 83 is molded in the nick 154.

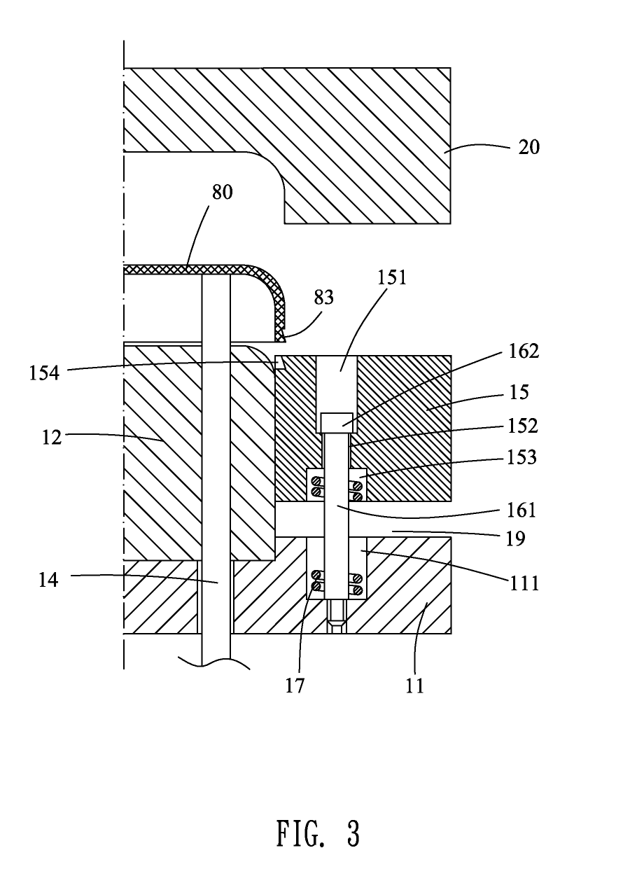

Referring to FIGS. 1-3, when the injection mold 1 is opened, the sliding block 15 moves upward under the bounce thrust of the spring 17 and the guide of the locating element 16 along the side surface of the movable core 12 to make the base portion 81 and the bending portion 82 of the product 80 parted from the top of the movable core 12. The blocking portion 162 of the locating element 16 is movably positioned in the receiving cavity 151. Two sides of a bottom of the blocking portion 162 of the locating element 16 can resist against the inner bottom sidewall of the receiving cavity 151 to block the sliding block 15 overly moving upward. So an elastic retraction area 40 is formed among the product 80, the top surface of the movable core 12 and the arc-shaped interface 122. At this time, the bottom of the sliding block 15 is spaced a distance from the top of the movable plate 11 to define an opening 19 between the bottom of the sliding block 15 and the top of the movable plate 11. The spring 17 keeps a normal status and is located in the first receiving groove 153, the opening 19 and the second receiving groove 111. Then the fixing plate drives the ejector pin 14 to move upward along the ejector pin hole 121 to push a bottom of the base portion 81 of the product 80 upward to make the barb 83 of the product 80 parted from the movable core 12. The barb 83 can be retracted towards the movable core 12 through the elastic retraction area 40, so the barb 83 is able to be parted from the movable core 12 directly without any deformation. Therefore, the product 80 can be ejected out of the movable mold 10 effectively to ensure a production of the product 80.

As described above, when the injection mold 1 is opened, the fixing plate drives the ejector pin 14 to move upward along the ejector pin hole 121 to push a bottom of the base portion 81 of the product 80 upward to make the barb 83 of the product 80 parted from the sliding block 15. The barb 83 can be refracted towards the movable core 12 through the elastic retraction area 40, so the barb 83 is able to be parted from the sliding block 15 directly without any deformation. Therefore, the product 80 can be ejected out of the movable mold 10 effectively to ensure a production of the product 80. Furthermore, the sliding block 15 is driven to vertically move upward and downward along the side surface of the movable core 12 under the cooperation of the locating element 16 and the spring 17, so the sliding block 15 occupies a smaller area in the injection mold 1 to make the injection mold 1 occupy a smaller area. So cost of manufacturing the injection mold 1 is decreased, and production efficiency of the injection mold 1 is improved.

The forgoing description of the present invention has been presented for purposes of illustration and description. It is not intended to be exhaustive or to limit the invention to the precise form disclosed, and obviously many modifications and variations are possible in light of the above teaching. Such as other embodiments, in which the spring 17 is just assembled to the movable plate 11 or the sliding block 15, the receiving cavity 151 is only opened in the bottom of the stationary mold 20 or opened between the top of the sliding block 15 and the bottom of the stationary mold 20. Such modifications and variations that may be apparent to those skilled in the art are intended to be included within the scope of this invention as defined by the accompanying claims.

What is claimed is:

1. An injection mold for molding a product having a barb at a bottom thereof, comprising:
a stationary mold defining a sprue channel, a bottom of the stationary mold being concaved upward to form a groove;
a movable mold positioned under the stationary mold when the injection mold is closed, the movable mold including a movable core which has a top thereof received in the groove of the stationary mold and spaced from an inner periphery of the groove to define a base groove therebetween;
an ejector pin movably inserted in the movable mold for ejecting the product out of the injection mold; and
a sliding mechanism including a sliding block movably mounted on a top of the movable mold and adjacent to one side of the movable core, a spring contracted between the sliding block and the movable mold, and a locating element vertically inserted in the spring through the sliding block, a top of the sliding block abutting against the bottom of the stationary mold to together define a receiving cavity therebetween, a bottom end of the locating element being fastened to the movable mold and a top end thereof stretching in the receiving cavity, a corner of the sliding block adjacent to the movable core defining a nick connected with the base groove for molding the barb of the product, the nick cooperating with the base groove to together define a shaping cavity for molding the product;
wherein when the injection mold is opened, the sliding block moves upward under the bounce thrust of the spring and the guide of the locating element along the one side of the movable core to make the product parted from the top of the movable core, the top end of the locating element can resist against a bottom side of the receiving cavity to block the sliding block overly moving upward, an elastic retraction area is accordingly formed between the product and the movable core for assisting the ejector pins to eject the barb out of the sliding block.

2. The injection mold as claimed in claim 1, wherein the locating element is of substantial T-shape, and has an inserting portion and a blocking portion perpendicularly connected with a top end of the inserting portion, the blocking portion is movably positioned in the receiving cavity and has two ends thereof resist against the bottom side of the receiving cavity when the injection mold is opened.

3. The injection mold as claimed in claim 2, wherein a bottom of the sliding block abuts against the top of the movable mold to together define a receiving groove therebetween for receiving the spring therein when the injection mold is closed, a connecting groove is connected between the receiving cavity and the receiving groove, the inserting portion of the locating element is inserted in the spring through the receiving cavity and the connecting groove.

4. The injection mold as claimed in claim 1, wherein the bottom end of the locating element is fastened to the movable mold by a screw.

5. The injection mold as claimed in claim 1, wherein an arc-shaped interface is provided on the top of the movable core to smoothly connect a top surface of the movable core with the one side of the movable core adjacent to the sliding block, the elastic retraction area is formed among the product, the top surface of the movable core and the arc-shaped interface when the injection mold is opened.
